(19) United States
(12) Patent Application Publication
(10) Pub. No.: US 2022/0227205 A1
(43) Pub. Date: Jul. 21, 2022

(54) TEMPERATURE MANAGEMENT SYSTEM

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kenichi MITANI, Mie (JP)

(21) Appl. No.: 17/613,781

(22) PCT Filed: Mar. 9, 2020
(86) PCT No.: PCT/JP2020/009908

§ 371 Date: Nov. 23, 2021

(30) Foreign Application Priority Data
Jun. 5, 2019 (JP) 2019-105155

(51) Int. Cl. B60H 1/00; B60K 11/02

(52) U.S. Cl. CPC B60H 1/00571; B60H 1/00885; B60K 11/02

(57) ABSTRACT

An object of the present disclosure is to achieve a reduction in the space taken up by a temperature management system in an electric automobile. A temperature management system for an electric automobile includes: an air-conditioning refrigerant circuit through which a refrigerant for adjusting a temperature in a passenger compartment of the electric automobile flows; a high-voltage device refrigerant circuit through which a refrigerant for cooling a high-voltage device flows; a battery refrigerant circuit through which a refrigerant for cooling a battery flows; and a tank that stores a refrigerant, wherein the air-conditioning refrigerant circuit, the high-voltage device refrigerant circuit, and the battery refrigerant circuit are connected to the tank, and a refrigerant is supplied from the tank to the air-conditioning refrigerant circuit, the high-voltage device refrigerant circuit, and the battery refrigerant circuit.

### TECHNICAL FIELD

The present disclosure relates to a temperature management system.

### BACKGROUND

Patent Document 1 discloses a system for cooling an inverter and a battery in an electric automobile. This system includes a reserve tank that stores a liquid, a first circulation path, and a second circulation path. The first circulation path allows the liquid to be circulated between the reserve tank, the inverter, and the radiator. The second circulation path allows the liquid to be circulated between the reserve tank and the battery.

### PRIOR ART DOCUMENT

### Patent Document

Patent Document 1: JP 2014-058241 A

### SUMMARY OF THE INVENTION

### Problems to be Solved

Meanwhile, an air-conditioning refrigerant circuit may be provided in an electric automobile. In this case, an air-conditioning refrigerant tank is provided separately. In recent years, there has been an increasing demand for further space saving in automobiles.

Therefore, an object of the present disclosure is to achieve a reduction in the space taken up by a temperature management system in an electric automobile.

### Means to Solve the Problem

A temperature management system according to the present disclosure is a temperature management system for an electric automobile, including: an air-conditioning refrigerant circuit through which a refrigerant for adjusting a temperature in a passenger compartment of the electric automobile flows; a high-voltage device refrigerant circuit through which a refrigerant for cooling a high-voltage device flows; a battery refrigerant circuit through which a refrigerant for cooling a battery flows; and a tank that stores a refrigerant, wherein the air-conditioning refrigerant circuit, the high-voltage device refrigerant circuit, and the battery refrigerant circuit are connected to the tank, and a refrigerant is supplied from the tank to the air-conditioning refrigerant circuit, the high-voltage device refrigerant circuit, and the battery refrigerant circuit.

### Effect of the Invention

According to the present disclosure, it is possible to achieve a reduction in the space taken up by a temperature management system in an electric automobile.

### BRIEF DESCRIPTION OF THE DRAWINGS

FIG. 1 is a diagram showing a temperature management system according to Embodiment 1.

FIG. 2 is a diagram showing an exemplary arrangement of portions through which a refrigerant passes in the temperature management system.

FIG. 3 is a schematic cross-sectional view showing a pipe and wires.

FIG. 4 is a schematic cross-sectional view showing a pipe and a wire according to another example.

FIG. 5 is a schematic cross-sectional view showing a refrigerant pipe and a wire according to another example.

FIG. 6 is a schematic cross-sectional view showing a refrigerant pipe and wires according to another example.

### DETAILED DESCRIPTION TO EXECUTE THE INVENTION

Description of Embodiments of the Present Disclosure

First, aspects of the present disclosure will be listed and described.

A temperature management system according to the present disclosure is as follows.

(1) A temperature management system for an electric automobile includes: an air-conditioning refrigerant circuit through which a refrigerant for adjusting a temperature in a passenger compartment of the electric automobile flows; a high-voltage device refrigerant circuit through which a refrigerant for cooling a high-voltage device flows; a battery refrigerant circuit through which a refrigerant for cooling a battery flows; and a tank that stores a refrigerant, wherein the air-conditioning refrigerant circuit, the high-voltage device refrigerant circuit, and the battery refrigerant circuit are connected to the tank, and a refrigerant is supplied from the tank to the air-conditioning refrigerant circuit, the high-voltage device refrigerant circuit, and the battery refrigerant circuit. Accordingly, the refrigerant is supplied from the same tank to the air-conditioning refrigerant circuit, the high-voltage device refrigerant circuit, and the battery refrigerant circuit. This makes it possible to reduce the number of tanks to be installed. Thus, it is possible to achieve a reduction in the space taken up by a temperature management system.

(2) The battery refrigerant circuit may be routed through a lithium ion battery serving as the battery. This allows the lithium ion battery to be efficiently cooled by a water-cooled cooling system.

(3) The high-voltage device refrigerant circuit may include a front high-voltage device refrigerant circuit and a rear high-voltage device refrigerant circuit, the front high-voltage device refrigerant circuit may be routed through a front high-voltage device provided on a front side in the electric automobile, the rear high-voltage device refrigerant circuit may be routed through a rear high-voltage device provided on a rear side in the electric automobile, and the refrigerant from the tank may separately flow through the front high-voltage device refrigerant circuit and the rear high-voltage device refrigerant circuit. Accordingly, effective cooling is performed between the front side and the rear side of the electric automobile.

(4) The temperature management system may further include a radiator that cools a refrigerant, wherein the high-voltage device refrigerant circuit and the battery refrigerant circuit may be routed through the radiator via separate flow paths. This makes it possible to separately manage the temperatures of the refrigerant flowing through the high-voltage device refrigerant circuit and the refrigerant flowing through the battery refrigerant circuit, while using the same radiator.

(5) The temperature management system may further include a heat exchanger that exchanges heat between the air-conditioning refrigerant circuit and the battery refrigerant circuit. This makes it possible to manage the temperature of the refrigerant flowing through the battery refrigerant circuit, using the refrigerant flowing through the air-conditioning refrigerant circuit.

(6) The temperature management system may further include a wire, at least a portion of which is disposed along at least a portion of the air-conditioning refrigerant circuit, the high-voltage device refrigerant circuit, and the battery refrigerant circuit. This allows the wire and the refrigerant circuit to be mounted in a compact form in the vehicle.

(7) The wire may be a wire having a heat-resistant temperature of 175° C. or less in a long-term heat aging test according to ISO 6722, a heat-resistant temperature of 175° C. or less in a short-term heat aging test according to ISO 6722, and a heat-resistant temperature of 175° C. or less in an overload heating test according to ISO 6722. At least a portion of the wire is disposed along at least a portion of the air-conditioning refrigerant circuit, the high-voltage device refrigerant circuit, and the battery refrigerant circuit. This allows the wire to be efficiently cooled. Accordingly, a wire having a heat-resistant temperature of 175° C. or less in a long-term heat aging test according to ISO 6722, a heat-resistant temperature of 175° C. or less in a short-term heat aging test according to ISO 6722, and a heat-resistant temperature of 175° C. or less in an overload heating test according to ISO 6722 may be used as the wire.

Details of Embodiments of the Present Disclosure

Specific examples of a temperature management system according to the present disclosure will be described below with reference to the drawings. It should be noted that the present disclosure is not limited to these examples, but is defined by the claims, and is intended to include all modifications which fall within the scope of the claims and the meaning and scope of equivalents thereof.

### Embodiment 1

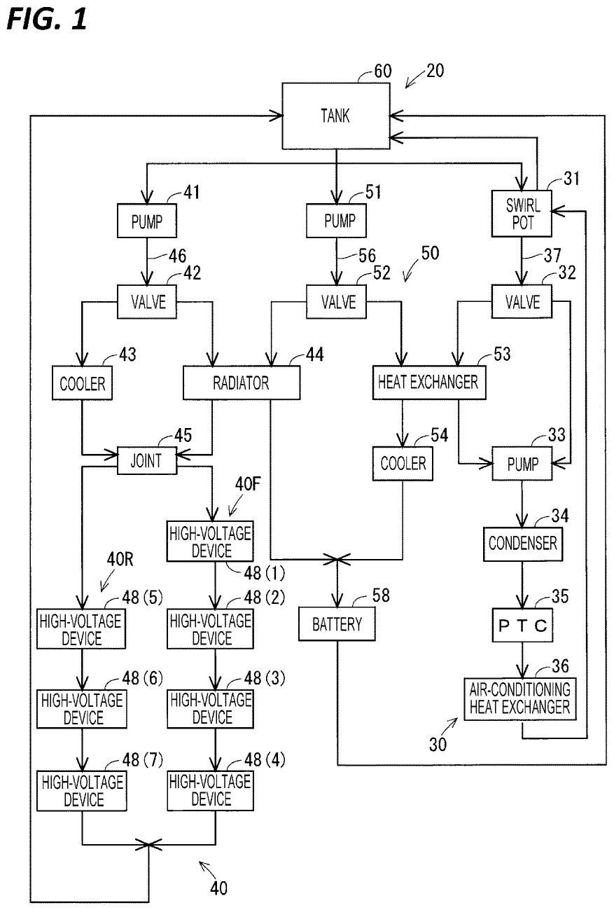

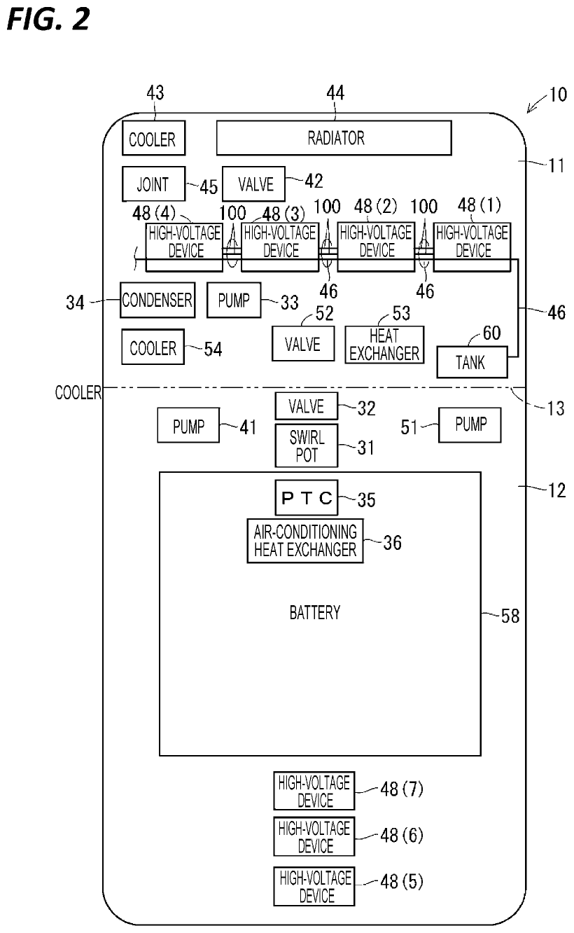

In the following, a temperature management system according to an embodiment will be described. FIG. 1 is a diagram showing a temperature management system 20 according to an embodiment, and FIG. 2 is a diagram showing an exemplary arrangement of portions through which a refrigerant passes in the temperature management system 20. Note that FIG. 2 schematically shows the shape of an electric automobile 10. A front compartment 11 is provided on the front side of the electric automobile 10, and a passenger compartment 12 is provided on the rear side thereof. A partition wall 13 is provided between the front compartment 11 and the passenger compartment 12. A motor for driving the electric automobile 10 to travel may be provided in the front compartment 11. If the electric automobile 10 has an internal combustion engine, the internal combustion engine may be provided in the front compartment 11. Here, the front and the rear as mentioned with regard to the electric automobile 10 are defined with respect to a normal traveling direction of the electric automobile 10. The normal traveling direction of the electric automobile 10 is the front side, and the backward direction is the rear side.

The temperature management system 20 is incorporated in the electric automobile 10. The description here will be given assuming that the electric automobile 10 is a battery electric vehicle (BEV). Here, a BEV is a vehicle that includes a battery charged by an external power supply and travels using the energy stored in the battery. Here, a BEV means a vehicle that travels using only the energy stored in the battery as the power source. Note that the temperature management system 20 of the present embodiment can be applied not only to a BEV, but also to an electric automobile that travels in response to the driving of an electric motor.

In order to drive the electric motor, a high-voltage electric device 48 and a battery 58 are mounted on the electric automobile 10. The temperature management system 20 is effective at managing the temperatures of the high-voltage electric device 48 and the battery 58. Note that a high voltage refers to a voltage greater than 60 V, for example. Accordingly, a high-voltage electric device is an electric device to which a voltage greater than, for example, 60 V is applied. The battery 58 is a battery that supplies power for causing the electric automobile 10 to travel. The voltage supplied from the battery 58 is, for example, 400 to 800 V. For the electric automobile 10, a refrigerant is used to adjust the temperature in the passenger compartment 12. The temperature management system 20 is effective at managing the temperature of such a refrigerant. In addition to the above-described BEV, a hybrid electric vehicle (HEV), a plug-in hybrid electric vehicle (PHEV), a fuel cell vehicle (FCV), and so forth are envisaged as the electric automobile 10 that travels in response to the driving of the electric motor.

Regarding Temperature Management System

The temperature management system 20 includes an air-conditioning refrigerant circuit 30, a high-voltage device refrigerant circuit 40, a battery refrigerant circuit 50, and a tank 60.

The air-conditioning refrigerant circuit 30 is a refrigerant circuit through which a refrigerant for adjusting the temperature in the passenger compartment 12 of the electric automobile 10 flows.

The high-voltage device refrigerant circuit 40 is a refrigerant circuit through which a refrigerant for cooling the high-voltage electric device 48 flows.

The battery refrigerant circuit 50 is a refrigerant circuit through which a refrigerant for cooling the battery 58 flows.

The tank 60 is a tank that stores a refrigerant.

The air-conditioning refrigerant circuit 30, the high-voltage device refrigerant circuit 40, and the battery refrigerant circuit 50 are connected to the same tank 60. The refrigerant is supplied from the tank 60 to the air-conditioning refrigerant circuit 30, the high-voltage device refrigerant circuit 40, and the battery refrigerant circuit 50.

The refrigerant circuits 30, 40, and 50, and the tank 60 will be described in more detail.

The tank 60 is mounted in the electric automobile 10. The tank 60 is provided, for example, in the front compartment 11. In FIG. 2, the tank 60 is provided at a position of the front compartment 11 that is located toward the passenger compartment 12 and is located toward one side.

The high-voltage device refrigerant circuit 40 is a circuit through which a refrigerant is to be passed. The high-voltage device refrigerant circuit 40 is configured to be routed through high-voltage electric devices 48(1), 48(2), 48(3), 48(4), 48(5), 48(6), and 48(7). In FIGS. 1 and 2, the high-voltage electric devices are abbreviated as high-voltage devices. The high-voltage electric devices 48(1), 48(2), 48(3), 48(4), 48(5), 48(6), and 48(7) collectively may be referred to as a high-voltage electric device 48.

More specifically, the high-voltage device refrigerant circuit 40 includes a pump 41, a valve 42, a cooler 43, a radiator 44, a joint 45, and a pipe 46. Note that a part of the pipe 46 is illustrated in FIG. 2.

The pump 41 is connected to the tank 60. The pump 41 delivers the refrigerant contained in the tank 60 such that the refrigerant passes through the devices via the pipe 46.

The valve 42 is a two-way switching valve. An upstream connection port of the valve 42 is connected to the pump 41. One of two downstream connection ports of the valve 42 is connected to the cooler 43, and the other is connected to the radiator 44. Under control performed by a control unit, the valve 42 switches the flow direction of the refrigerant between the cooler 43 side and the radiator 44 side. The switching may be performed between at least two of three states, namely, a state in which the refrigerant flows only through the cooler 43, a state in which the refrigerant flows only through the radiator 44, and a state in which the refrigerant flows through both the cooler 43 and the radiator 44.

The cooler 43 is a portion that cools the refrigerant that has flowed through the valve 42. A heat exchanger may be used as the cooler 43. The cooler 43 may include a fan for forcefully cooling the refrigerant. Here, the cooler 43 is provided midway on an introduction path for introducing outside air for air-conditioning. In this case, the outside air for air-conditioning is heated by the waste heat of the cooler 43. That is, the waste heat of the cooler 43 is used as the energy for heating the interior of the passenger compartment 12.

The radiator 44 is a kind of heat exchanger that radiates the heat from a refrigerant. The radiator 44 is provided in a front portion of the electric automobile 10. Wind generated by travelling passes through the radiator 44 while the electric automobile 10 is in motion. The radiator 44 is efficiently cooled using the wind generated by traveling. A fan for blowing air to forcefully cool the radiator 44 may be provided.

The switching timing of the valve 42 may be controlled in the following manner. For example, in a normal state, the valve 42 is switched such that the refrigerant passes only through the radiator 44. When there is a need to increase the degree of cooling of the refrigerant, the valve 42 is switched such that the refrigerant passes through the radiator 44 and the cooler 43. When the outside air for air-conditioning is to be heated by the waste heat of the cooler 43, the valve 42 is switched such that the refrigerant passes only through the cooler 43, or passes through the radiator 44 and the cooler 43.

The joint 45 is, for example, a four-way joint (four-way connector). The refrigerant that has been cooled in the cooler 43 and the radiator 44 gathers at the joint 45, and thereafter branches in two directions and flow out. The refrigerant flowing out in two directions from the joint 45 flow via the high-voltage electric devices 48(1), 48(2), 48(3), 48(4), 48(5), 48(6), and 48(7).

The high-voltage device refrigerant circuit 40 includes, on the downstream side relative to the joint 45, a front high-voltage device refrigerant circuit 40F and a rear high-voltage device refrigerant circuit 40R. Refrigerant from the tank 60 flows separately through the front high-voltage device refrigerant circuit 40F and the rear high-voltage device refrigerant circuit 40R.

The front high-voltage device refrigerant circuit 40F is routed through the front high-voltage electric devices 48(1), 48(2), 48(3), and 48(4) that are provided on the front side of the electric automobile 10. This allows the front high-voltage electric devices 48(1), 48(2), 48(3), and 48(4) to be cooled by the refrigerant. The rear high-voltage device refrigerant circuit 40R is routed through the rear high-voltage electric devices 48(5), 48(6), and 48(7) that are provided on the rear side of the electric automobile 10. Here, the front high-voltage electric device and the rear high-voltage electric device refer to a high-voltage electric device located on the front side and a high-voltage electric device located on the rear side, respectively, relative to a given boundary when a plurality of high-voltage electric devices mounted in the electric automobile 10 are separated by the boundary in the front-rear direction of the electric automobile 10. The boundary need not necessarily be at the center of the electric automobile 10 in the front-rear direction. However, the high-voltage electric device located on the front side relative to a boundary at the center of the electric automobile 10 in the front-rear direction may be referred to as a front high-voltage electric device, and a high-voltage electric device located on the rear side relative to the boundary may be referred to as a rear high-voltage electric device.

The high-voltage electric devices (1), 48(2), 48(3), 48(4), 48(5), 48(6), and 48(7) are, for example, a wireless power feeding unit, an electric driving unit, a motor, a DC/DC converter, a charger, and so forth.

More specifically, the front high-voltage electric device 48(1) is, for example, a DC/DC converter. The DC/DC converter lowers the voltage of the battery 58. Various electric devices of the vehicle are connected to the DC/DC converter. As the electric devices, an electronic control unit (ECU), an actuator, a display device, a light-emitting diode, a lamp, an entertainment device, and so forth are envisaged.

The front high-voltage electric device 48(2) is, for example, a charger. The charger is supplied with power from an external device, and controls the charging of the battery 58.

The front high-voltage electric device 48(3) is, for example, an electric driving unit that controls the driving of a travel motor disposed on the front side. The electric driving unit is, for example, a unit in which a DC/AC inverter, a converter, and so forth are integrated as one piece. The converter controls the voltage. The DC/AC inverter drives the motor.

The front high-voltage electric device 48(4) is a motor for driving the front wheels.

Since the front high-voltage electric devices 48(1), 48(2), 48(3), and 48(4) are components that are likely to generate heat, it is desirable for these devices to be cooled by the temperature management system 20 of the present embodiment. In addition, the front high-voltage electric devices 48(1), 48(2), 48(3), and 48(4) are devices disposed on the front side of the electric automobile 10. Here, the front high-voltage electric devices 48(1), 48(2), 48(3), and 48(4) are disposed in the front compartment 11. Accordingly, the front high-voltage electric devices 48(1), 48(2), 48(3), and 48(4) are suitable to be cooled by the refrigerant flowing through the front high-voltage device refrigerant circuit 40F.

The rear high-voltage electric device 48(5) is, for example, a wireless power feeding unit. The wireless power feeding unit is supplied with power in a non-contact manner from an external device, and charges the battery 58.

The rear high-voltage electric device 48(6) is, for example, an electric driving unit that controls the driving of a travel motor disposed on the rear side. The electric driving unit is, for example, a unit in which a DC/AC inverter, a converter, and so forth are integrated as one piece. The DC/AC inverter drives the motor. The converter controls the voltage.

The front high-voltage electric device 48(7) is a motor for driving the rear wheels.

Since the rear high-voltage electric devices 48(5), 48(6), and 48(7) are components that are likely to generate heat, it is desirable for these devices to be cooled by the temperature management system 20 of the present embodiment. In addition, the rear high-voltage electric devices 48(5), 48(6), and 48(7) are devices disposed on the rear side of the electric automobile 10. Here, the rear high-voltage electric devices 48(5), 48(6), and 48(7) are disposed in a rear portion of the passenger compartment 12. Accordingly, the rear high-voltage electric devices 48(5), 48(6), and 48(7) are suitable to be cooled by the refrigerant flowing through the rear high-voltage device refrigerant circuit 40R.

The refrigerant that passes through the front high-voltage device refrigerant circuit 40F via the front high-voltage electric devices 48(1), 48(2), 48(3), and 48(4), and the refrigerant that passes through the rear high-voltage device refrigerant circuit 40R via the rear high-voltage electric devices 48(5), 48(6), and 48(7) return to the tank 60.

The pipe 46 is a resin or metal pipe through which the refrigerant flows. The pipe 46 is connected so as to link the above-described devices. The pipe 46 may exist between the devices as a pipe linking these devices. In each of the above-described devices, a pipe dedicated to heat exchange may be provided. In this case, the pipe 46 is connected to these pipes provided in the devices. Alternatively, the pipe 46 may be disposed so as to directly pass through the above-described devices. The order in which the pipe 46 passes through the high-voltage electric devices 48(1), 48(2), 48(3), and 48(4), or through the high-voltage electric devices 48(5), 48(6), and 48(7) is not limited to those shown in the above-described example. The order in which the refrigerant circuit passes through the above-described devices may be determined as appropriate, taking into account the degrees of heat generation, the working temperature ranges, the layout, and the like of the devices.

The battery refrigerant circuit 50 is a circuit through which a refrigerant is to be passed. The battery refrigerant circuit 50 is configured to be routed through the battery 58. Since the high-voltage device refrigerant circuit 40 and the battery refrigerant circuit 50 are configured as separate paths through which a refrigerant flows, the temperatures of the high-voltage electric device 48 and the battery 58 can be managed separately.

More specifically, the battery refrigerant circuit 50 includes a pump 51, a valve 52, a heat exchanger 53, a cooler 54, and a pipe 56.

The pump 51 is connected to the tank 60. The pump 51 delivers the refrigerant contained in the tank 60 such that the refrigerant passes through the devices via the pipe 56.

The valve 52 is a two-way switching valve. An upstream connection port of the valve 52 is connected to the pump 51. One of two downstream connection ports of the valve 52 is connected to the radiator 44, and the other is connected to the heat exchanger 53. Under control performed by the control unit, the valve 52 switches the flow direction of the refrigerant between the radiator 44 side and the heat exchanger 53 side. The switching may be performed between at least two of three states, namely, a state in which the refrigerant flows only through the radiator 44, a state in which the refrigerant flows only through the heat exchanger 53, and a state in which the refrigerant flows through both the radiator 44 and the heat exchanger 53. The switching timing of the valve 52 will be described later.

As described above, the radiator 44 is a heat exchanger that radiates the heat from the refrigerant. The radiator 44 is provided in a front portion of the electric automobile 10. The radiator 44 is the same as the radiator 44 to which the refrigerant flowing through the high-voltage device refrigerant circuit 40 flows. In the radiator 44, two flow paths are provided. The refrigerant flowing through the high-voltage device refrigerant circuit 40 flows through one of the two flow paths. The refrigerant flowing through the battery refrigerant circuit 50 flows through the other of the two flow paths. Accordingly, the refrigerant flowing through the high-voltage device refrigerant circuit 40 and the refrigerant flowing through the battery refrigerant circuit 50 are cooled by the same radiator 44. However, the two refrigerants flow through the radiator 44 without mixing with each other. Accordingly, the refrigerant flowing through the high-voltage device refrigerant circuit 40 and the refrigerant flowing through the battery refrigerant circuit 50 can have different temperatures.

The heat exchanger 53 exchanges the heat of the refrigerant with another heat. Here, the heat exchanger 53 exchanges heat between the refrigerant flowing through the battery refrigerant circuit 50 and the refrigerant flowing through the air-conditioning refrigerant circuit 30. Here, it is assumed that when the temperature of the refrigerant flowing through the battery refrigerant circuit 50 is relatively low, and the temperature of the refrigerant flowing through the air-conditioning refrigerant circuit 30 is relatively high, the temperature of the refrigerant flowing through the battery refrigerant circuit 50 is increased by exchanging heat between the two refrigerants.

A portion of the pipe 56 that is located downstream of the radiator 44 and a portion of the pipe that is located downstream of the heat exchanger 53 and the cooler 54 are disposed so as to merge into one and be routed through the battery 58. Accordingly, the refrigerant passing through the radiator 44 and the refrigerant passing through the heat exchanger 53 and the cooler 54 both flow into the battery 58. This allows the battery 58 to be cooled or heated by the refrigerant.

Refrigerant that has passed through the battery 58 returns to the tank 60 via the pipe 56.

The pipe 56 is a resin or metal pipe through which the refrigerant passes. As in the case of the pipe 46, the pipe 56 is connected so as to link the above-described devices.

The air-conditioning refrigerant circuit 30 is a circuit through which the refrigerant is to be passed. The refrigerant from the tank 60 can be supplied to the air-conditioning refrigerant circuit 30. However, the air-conditioning refrigerant circuit 30 is configured as a path that is separate from the high-voltage device refrigerant circuit 40 and the battery refrigerant circuit 50. Accordingly, the temperature of the air-conditioning refrigerant can be managed separately from the temperatures of the high-voltage electric device 48 and the battery 58.

More specifically, the air-conditioning refrigerant circuit 30 includes a degas swirl pot 31, a valve 32, a pump 33, a condenser 34, a PTC heater (Positive Temperature Coefficient heater) 35 , and an air-conditioning heat exchanger 36.

The degas swirl pot 31 serves the function of gathering bubbles contained in the air-conditioning refrigerant and returning the bubbles to the tank 60, using centrifugal force. The refrigerant in an amount corresponding to the bubbles returned to the tank 60 is supplemented to the air-conditioning refrigerant circuit 30 at any position of the degas swirl pot 31 or the air-conditioning refrigerant circuit 30. Accordingly, most of the refrigerant is circulated in the air-conditioning refrigerant circuit 30 without passing through the tank 60. However, the refrigerant is supplied from the tank 60 when there is a shortage of the refrigerant.

The valve 32 is a two-way switching valve. An upstream connection port of the valve 32 is connected to the degas swirl pot 31. One of two downstream connection ports of the valve 32 is connected to the heat exchanger 53, and the other connection port is connected to the pump 33. Under control performed by the control unit, the valve 32 switches the flow direction of the refrigerant between the heat exchanger 53 side and the pump 33 side. The switching may be performed between at least two of three states, namely, a state in which the refrigerant flows only through the heat exchanger 53, a state in which the refrigerant flows only through the pump 33, and a state in which the refrigerant flows through both the heat exchanger 53 and the pump 33. The switching timing of the valve 32 will be described later.

As described above, the heat exchanger 53 exchanges heat between the refrigerant flowing through the battery refrigerant circuit 50 and the refrigerant flowing through the air-conditioning refrigerant circuit 30. That is, the heat exchanger 53 exchanges heat between the air-conditioning refrigerant circuit 30 and the battery refrigerant circuit 50.

The heat exchanger 53 and the valve 32 are connected to the pump 33 via a pipe 37. That is, the refrigerant passing through the heat exchanger 53 flows into the pump 33. In addition, the refrigerant flows into the pump 33 directly from the valve 32.

The pump 33 delivers the refrigerant to the condenser 34, the PTC heater 35, and the air-conditioning heat exchanger 36 side.

The condenser 34 is provided in the front compartment 11 or the like. The condenser 34 is a kind of heat exchanger, and condenses the refrigerant through cooling. In particular, when the interior of the compartment is cooled, the condenser 34 operates to condense the refrigerant through cooling. When the interior of the compartment is not cooled, or is heated, the condenser 34 is in a non-operating state.

The PTC heater 35 is a heater for heating the refrigerant. More specifically, the PTC heater 35 is a heater having properties that make it difficult for electricity to flow therethrough as a result of the electrical resistance increasing following an increase in temperature due to a current flowing therethrough after being energized. Such a PTC heater 35 is advantageous in suppressing power consumption because its power consumption is suppressed once the temperature has increased. The PTC heater 35 is operated to heat the refrigerant when the interior of the passenger compartment 12 is heated, or when the battery 58 is heated. When the interior of the passenger compartment 12 is cooled, the PTC heater 35 is in a non-operating state. The heater for heating the refrigerant need not be a PTC heater. The heater may be a heater whose temperature is adjusted by being turned on or off using a thermostat or the like.

The air-conditioning heat exchanger 36 exchanges heat with air supplied to the interior of the passenger compartment 12. The air supplied to the interior of the passenger compartment 12 is cooled or heated according to the temperature of the refrigerant flowing through the air-conditioning heat exchanger 36. That is, when the refrigerant is cooled by the condenser 34, the air cooled by the air-conditioning heat exchanger 36 is supplied to the passenger compartment 12. When the refrigerant is heated by the PTC heater 35, the air heated by the air-conditioning heat exchanger 36 is supplied to the passenger compartment 12.

From the pump 33, the refrigerant passes through the condenser 34, the PTC heater 35, and the air-conditioning heat exchanger 36 in this order, and thereafter returns to the degas swirl pot 31 via the pipe 37.

The pipe 37 is a resin or metal pipe through which the refrigerant flows. As in the case of the pipe 46, the pipe 37 is connected so as to link the above-described devices.

The switching timing of the valve 52 and the valve 32 may be controlled in the following manner.

First, as the background, the battery 58 needs to be used in an appropriate temperature range. For example, a lithium ion battery needs to be used in a predetermined temperature range. In particular, some lithium ion batteries including a nickel-based positive electrode need to be used at 25° C. to 35° C. Accordingly, the battery 58 may need to be heated in a cold environment. In addition, the battery 58 is heated through charge/discharge, and therefore may need to be cooled when its temperature exceeds the above-described temperature range.

First, it is envisaged that the refrigerant temperature in the battery refrigerant circuit 50 is higher than the above-described temperature range, and the refrigerant temperature in the air-conditioning refrigerant circuit 30 is lower than the above-described temperature range. In this case, the valve 52 may be switched such that the refrigerant flows through the radiator 44 side, but not through the heat exchanger 53 side. This allows the refrigerant in the battery refrigerant circuit 50 to be efficiently cooled by the radiator 44. Accordingly, the battery 58 is cooled independent of the temperature of the air-conditioning refrigerant.

In this case, the valve 32 may be switched such that the refrigerant flows through the pump 33 side, or may be switched such that the refrigerant flows through the heat exchanger 53 side. In particular, it is assumed that the interior of the passenger compartment 12 is heated. In this case, the valve 32, which will be described below, may be switched such that the refrigerant flows through the pump 33 side. In addition, the air-conditioning refrigerant flows through the pump 33 without being cooled by the heat exchanger 53.

It is also envisaged that the refrigerant temperature in the battery refrigerant circuit 50 is lower than the above-described temperature range, and the refrigerant temperature in the air-conditioning refrigerant circuit 30 is lower than the above-described temperature range. In this case, the valve 52 may be switched such that the refrigerant flows through the heat exchanger 53 side. The valve 32 may be switched such that the refrigerant flows through the heat exchanger 53 side. Furthermore, the PTC heater 35 may be turned on so as to heat the refrigerant. Accordingly, the refrigerant heated by the PTC heater 35 flows through the heat exchanger 53. Then, heat is exchanged between the refrigerant on the air-conditioning refrigerant circuit 30 side and the refrigerant on the battery refrigerant circuit 50 side, whereby the refrigerant on the battery refrigerant circuit 50 side is heated. As a result of this refrigerant flowing through the battery 58, the battery 58 is heated.

The refrigerant in the air-conditioning refrigerant circuit 30 is a refrigerant for heating the passenger compartment 12. Therefore, the temperature range of the refrigerant in the air-conditioning refrigerant circuit 30 is also suitable for heating the battery 58 to the above-described temperature range of 25° C. to 35° C.

It is also envisaged that the refrigerant temperature in the battery refrigerant circuit 50 is higher than the above-described temperature range, and the refrigerant temperature in the air-conditioning refrigerant circuit 30 is higher than the above-described temperature range. In this case, the valve 52 may be switched such that the refrigerant flows through the radiator 44 side. Accordingly, the refrigerant in the battery refrigerant circuit 50 is efficiently cooled by the radiator 44, independent of the temperature of the air-conditioning refrigerant.

In this case, the valve 32 may be switched such that the refrigerant flows through the pump 33 side, or may be switched such that the refrigerant flows through the heat exchanger 53 side. Here, it is assumed that the interior of the passenger compartment 12 is to be cooled. In this case, the PTC heater 35 may be brought into a non-operating state, and the condenser 34 may be operated so as to cool the air-conditioning refrigerant.

It is also envisaged that the refrigerant temperature in the battery refrigerant circuit 50 is lower than the above-described temperature range, and the refrigerant temperature in the air-conditioning refrigerant circuit 30 is higher than the above-described temperature range. In this case, the valve 52 may be switched such that the refrigerant flows through the heat exchanger 53. The valve 32 may be switched such that the refrigerant flows through the heat exchanger 53 side. Accordingly, heat is exchanged between the refrigerant on the air-conditioning refrigerant circuit 30 side and the refrigerant on the battery refrigerant circuit 50 side, whereby the refrigerant on the battery refrigerant circuit 50 is heated. As a result of this refrigerant flowing through the battery 58, the battery 58 is heated.

As described above, the refrigerant in the air-conditioning refrigerant circuit 30 is a refrigerant for heating the passenger compartment 12. Therefore, the temperature range of the refrigerant in the air-conditioning refrigerant circuit 30 is also suitable for heating the battery 58 to the above-described temperature range of 25° C. to 35° C.

In this manner, the PTC heater 35 for heating the passenger compartment 12 is also used for the purpose of heating the battery 58 via the refrigerant.

According to the present embodiment, the refrigerant is supplied from the same tank 60 to the air-conditioning refrigerant circuit 30, the high-voltage device refrigerant circuit 40, and the battery refrigerant circuit 50. This makes it possible to reduce the number of tanks 60 to be installed. Thus, it is possible to achieve a reduction in the space taken up by the temperature management system 20 in the electric automobile 10.

In particular, in the field of electric automobiles, a water-cooled cooling system is used for an air-conditioning system including the PTC heater 35 and the like, a cooling system for cooling the high-voltage electric device 48, and a cooling system for cooling the battery 58. In particular, BEVs produce no waste heat resulting from fuel combustion, unlike gasoline automobiles or diesel automobiles, and therefore require an air-conditioning system using the PTC heater 35 and the like. In an electric automobile, a high-voltage electric device 48 to which a voltage greater than 60 V is applied is mounted, for example. In order to cause the electric automobile 10 to travel, a battery 58 with a supply voltage of 400 to 800 V is mounted. In what way these devices are to be cooled has been an important issue. The present disclosure contributes to solving such an important issue.

In recent years, there has been an increasing need for further space saving in automobiles. A water-cooled cooler requires space from the viewpoint of supplying the refrigerant, as compared with an air-cooled cooler. According to the present disclosure, the refrigerant is supplied from the same tank 60, and therefore the present disclosure contributes to space saving.

The air-conditioning refrigerant circuit 30 is required to perform cooling and heating. The high-voltage device refrigerant circuit 40 is required to cool the high-voltage electric device 48 in a dedicated manner. The battery refrigerant circuit 50 is required to manage the temperature so as to be suitable for charge/discharge. As for the refrigerant supplied from the tank 60, the refrigerant in the air-conditioning refrigerant circuit 30, the refrigerant in the high-voltage device refrigerant circuit 40, and the refrigerant in the battery refrigerant circuit 50 are separately cooled, and also heated as needed. Accordingly, appropriate temperatures of the circuits 30, 40, and 50 can each be managed separately.

The battery refrigerant circuit 50 is routed through a lithium ion battery serving as the battery 58. This allows the lithium ion battery to be efficiently cooled by the water-cooled cooling system.

In particular, in recent years, there has been an increasing demand for a greater traveling distance per charge of an electric automobile in the market. As an example, there is demand to be able to travel a distance of 500 km or more per charge. In order to increase the traveling distance per charge of an electric automobile, attempts have been made to use a lithium ion battery as the battery of the electric automobile in place of a nickel battery. For a lithium ion battery, the temperature range suitable for charge or discharge is predetermined. This has resulted in the problem that a state unsuitable for charge or discharge occurs as the amount of heat generated by the lithium ion battery increases. In particular, as the lithium ion battery, a lithium ion battery for which a nickel-based material is used as the positive electrode is being developed. Using a nickel-based material as the positive electrode makes it possible to increase the capacity, but requires strict temperature management. According to the present embodiment, the battery 58 is cooled by the refrigerant flowing through the battery refrigerant circuit 50, and therefore temperature management is appropriately performed for such a lithium ion battery as well.

The high-voltage device refrigerant circuit 40 includes the front high-voltage device refrigerant circuit 40F and the rear high-voltage device refrigerant circuit 40R. Accordingly, the front side and the rear side of the electric automobile 10 can be effectively cooled.

The high-voltage device refrigerant circuit 40 and the battery refrigerant circuit 50 are routed through the same radiator 44 via separate flow paths. This makes it possible to separately manage the temperatures of the refrigerant flowing through the high-voltage device refrigerant circuit 40 and the refrigerant flowing through the battery refrigerant circuit 50, while using the same radiator 44.

The air-conditioning refrigerant circuit 30 and the battery refrigerant circuit 50 can exchange heat via the heat exchanger 53. This makes it possible to manage the temperature of the refrigerant flowing through the battery refrigerant circuit 50, using the refrigerant flowing through the air-conditioning refrigerant circuit 30.

Regarding Cooling Structure of Wire

It can be understood that the temperature management system 20 according to the present embodiment further includes a wire 100, at least a portion of which is disposed along at least a portion of the air-conditioning refrigerant circuit 30, the high-voltage device refrigerant circuit 40, and the battery refrigerant circuit 50.

In FIG. 2, a wire 100 that connects the high-voltage electric devices 48(1), 48(2), 48(3), and 48(4) is depicted, as an example. In addition, a pipe 46 is disposed between the high-voltage electric devices 48(1), 48(2), 48(3), and 48(4). The pipe may be either of the pipe 37 and 46. The wire 100 may be a wire connected to the battery 58, or a wire connected to the PTC heater 35.

The wire 100 is disposed along the pipe 46. The wire 100 is an example of a high-voltage wire. Here, the high-voltage wire is, for example, a wire to which a voltage greater than 60 V is applied. Such a wire 100 is likely to generate heat since a high voltage is applied thereto. The wire 100 is effectively cooled by the refrigerant flowing through the high-voltage device refrigerant circuit 40. Since the wire 100 is disposed along the pipe 46, the pipe 46 and the wire 100 are mounted in a compact form in the electric automobile 10. In addition, the pipe 46 and the wire 100 are easily simultaneously incorporated between the high-voltage electric devices 48(1), 48(2), 48(3), and 48(4).

The wire 100 is configured to be disposed along the pipe 46, and thus the wire 100 is efficiently cooled. Accordingly, the heat-resistant temperature required for the wire 100 can be lowered. As the wire 100, it is possible to use, for example, a wire having a heat-resistant temperature of 175° C. or less in a long-term heat aging test according to ISO 6722, a heat-resistant temperature of 175° C. or less in a short-term heat aging test according to ISO 6722, and a heat-resistant temperature of 175° C. or less in an overload heating test according to ISO 6722. In other words, a wire of Class E of the required properties according to ISO 6722, or a wire of a lower class (wire of Class D, Class C, Class B, or Class A) may be used as the wire 100.

This makes it possible to realize cost reduction and the like.

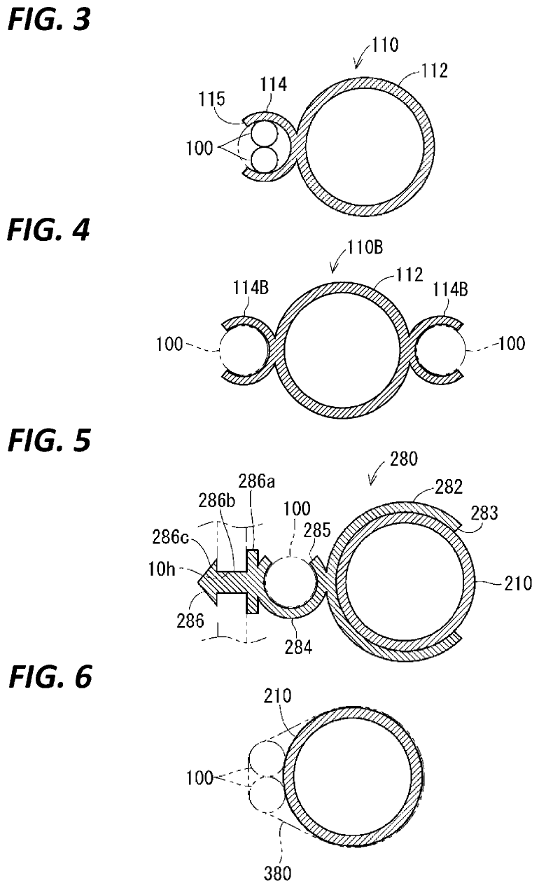

An exemplary configuration for holding the wire 100 so as to be disposed along the pipe 110 will be described. FIG. 3 is a schematic cross-sectional view showing a first exemplary configuration for disposing the wire 100 along the pipe 110. The pipe 110 is an example of the pipe that can be applied to the pipes 37, 46, and 56.

The pipe 110 has a configuration in which a pipe body portion 112 and a wire holding portion 114 are formed integrally as one piece. The pipe 110 is formed, for example, by extrusion molding a resin.

The pipe body portion 112 is formed in a tubular shape that allows a refrigerant to pass therethrough.

The wire 100 includes a core wire, and an insulating coating surrounding the core wire. The core wire may be a solid wire, or may be a stranded wire. The insulating coating is formed, for example, by by subjecting the core wire to extrusion coating. Here, the transverse cross-sectional shape (the shape of a cross section orthogonal to the axial direction) of the wire 100 is a circular shape. The transverse cross-sectional shape of the wire 100 may be a square shape, a rectangular shape, or the like. Here, an example is shown in which two wires 100 are held along the pipe 110. The number of wires 100 may be one, or may be three. In the following, the smallest circle that is in contact with the outer circumference of one or more wires 100 may be referred to as a circumscribed circle.

The wire holding portion 114 is formed so as to protrude outward from a portion of the outer circumference of the pipe body portion 112. The wire holding portion 114 is formed in a tubular shape having a slit 115 formed in a portion of the outer circumference thereof. The inner diameter of the wire holding portion 114 is set to be a size large enough to house the wire 100 therein. For example, the inner diameter of the wire holding portion 114 is set to be about the same as the diameter of the circumscribed circle of the wire 100. The width of the slit 115 is set to be a size large enough to house the wire 100 in the wire holding portion 114 using the elastic deformation of the wire holding portion 114, and to prevent the wire 100 from falling out of the wire holding portion 114 in a state in which the wire 100 is housed in the wire holding portion 114. For example, the width of the slit 115 is set to be smaller than the diameter of the circumscribed circle of the wire 100, and larger than the radius thereof. Here, the slit 115 is open to the side opposite to the pipe body portion 112. The position at which the slit 115 is open may be another position.

As a result of the slit 115 being opened through elastic deformation of the wire holding portion 114, the wire 100 is housed in the wire holding portion 114. In a state in which the wire 100 is housed in the wire holding portion 114, the wire holding portion 114 is elastically restored to its original shape. Then, the slit 115 is closed, whereby the wire 100 is held by the wire holding portion 114. This allows the wire 100 to be kept held along the pipe 110.

FIG. 4 is a schematic diagram showing a modification of the pipe 110 shown in FIG. 3. A pipe 110B according to this modification includes a pipe body portion 112, and a plurality of (here, two) wire holding portions 114B.

The pipe body portion 112 and the plurality of wire holding portions 114B are molded as a single piece using a resin or the like. Here, the two wire holding portions 114B are provided on opposite sides of the pipe body portion 112. The plurality of wire holding portions may be provided adjacent to each other on the outer circumferential side of the pipe body portion.

The wire holding portions 114B are each configured in the same manner as the wire holding portion 114 described above. The wire holding portions 114B are each formed in a size large enough to hold a wire 100 that is to be held therein. The width of each slit 115 is set to be a size large enough to house the wire 100 in each wire holding portion 114B using elastic deformation of the wire holding portion 114B, and to prevent the wire 100 from falling out.

According to the example shown in FIG. 3 or 4, the wire 100 is easily attached along the pipe 110 or 110B.

Since the pipe 110 or 110B and the wire 100 are supplied in an integrated form, the ease of attachment to the electric automobile 10 is increased. It is also possible that the pipe 110 or 110B and the wire 100 are provided in separate forms, and they are integrated with each other when attached to the electric automobile 10. This allows the attachment operation to be performed in a flexible manner.

Since the wire 100 is attached close to the pipe 110 or 110B, the effect of cooling the wire 100 is increased.

In particular, in the example show in FIG. 4, a plurality of (here, two) wires 100 are held in one-to-one correspondence by a plurality of (here, two) wire holding portions 114B. Accordingly, the wires 100 are held close to the pipe body portion 112, and the wires 100 are effectively cooled.

FIG. 5 is a schematic cross-sectional view showing a second exemplary configuration for disposing the wire 100 along a pipe 210. The pipe 210 is an example of a pipe that can be applied to the pipes 37,46, and 56.

In the present example, the wire 100 is held along the pipe 210 by an attachment member 280.

The attachment member 280 includes a pipe attachment portion 282 and a wire attachment portion 284. The attachment member 280 is made of a resin or the like.

The pipe attachment portion 282 is an annular portion having an opening 283 formed in a portion thereof in the circumferential direction, or in other words, is a C-shaped member. The pipe attachment portion 282 is set to have an inner diameter capable of housing the pipe 210. The opening 283 is set to be smaller than the diameter of the pipe 210. Also, the opening 283 is opened by elastically deforming the pipe attachment portion 282. Through the opened opening 283, the pipe 210 is housed in the pipe attachment portion 282. In this state, the pipe attachment portion 282 is elastically restored to its original shape, whereby the pipe attachment portion 282 is attached to the pipe 210.

The wire attachment portion 284 is an annular portion having an opening 285 formed in a portion thereof in the circumferential direction, or in other words, is a C-shaped member. The wire attachment portion 284 is set to have an inner diameter capable of housing the wire 100. The opening 285 is set to be smaller than the diameter of the circumscribed circle of the wire 100. Also, the opening 285 is opened by elastically deforming the wire attachment portion 284. Through the opened opening 285, the wire 100 is housed in the wire attachment portion 284. In this state, the wire attachment portion 284 is elastically restored to its original shape, whereby the wire attachment portion 284 is attached to the wire 100.

The attachment member 280 is a short member that is partially attached to the wire 100 and the pipe 210 in the extension direction thereof. The attachment member 280 may be an elongated member that is attached to the wire 100 and the pipe 210 over a certain length.

Note that the directions of the opening 283 of the pipe attachment portion 282 and the opening 285 of the wire attachment portion 284 may be any directions.

In the present example, the attachment member 280 includes a vehicle fixing portion 286 that is to be fixed to the vehicle. Here, the vehicle fixing portion 286 includes a base portion 286a, a columnar portion 286b, and catch portions 286c. The base portion 286a is formed in a disc shape or a dish shape. The base portion 286a is molded integrally with the wire attachment portion 284 at a position adjacent to a portion of the outer circumference of the wire attachment portion 284. The base portion may be formed integrally with the pipe attachment portion at a position adjacent to a portion of the outer circumference of the pipe attachment portion.

The columnar portion 286b is an oblong columnar portion protruding outward from the center of the base portion 286a.

A pair of catch portions 286c are provided at a distal end portion of the columnar portion 286b. The outward facing surface of each catch portion 286c is formed so as to be inclined outward from the distal end portion to a proximal end portion of the columnar portion 286b.

Also, when the vehicle fixing portion 286 is inserted into a fixing hole 10h formed in the body of the electric automobile 10, and the catch portions 286c have moved through the fixing hole 10h, the catch portions 286c are caught on a portion of the electric automobile 10 that is located around the fixing hole 10h. Consequently, the portion of the electric automobile 10 that is located around the fixing hole 10h is sandwiched between the catch portions 286c and the base portion 286a. Accordingly, the vehicle fixing portion 286 is fixed to the electric automobile 10.

The configuration of the vehicle fixing portion 286 is not limited to the above-described example. The vehicle fixing portion may be a portion that is to be fixed to the vehicle through screwing, or a portion that is to be fixed to the vehicle through welding or the like. The vehicle fixing portion 286 may be omitted.

According to the present example, by using the attachment member 280, the wire 100 can be easily attached to the pipe 210.

Since the pipe 210 and the wire 100 are supplied in an integrated form, the ease of attachment to the electric automobile 10 is increased. It is also possible that the pipe 210 and the wire 100 are provided in separate forms, and they are integrated with each other using the attachment member 280 when being attached to the electric automobile 10. This allows the attachment operation to be performed in a flexible manner.

By fixing the vehicle fixing portion 286 to the electric automobile 10, it is possible to fix the wire 100 and the pipe 210 to the vehicle.

FIG. 6 is a schematic cross-sectional view showing a third exemplary configuration for disposing the wire 100 along the pipe 210.

In the present example, the wires 100 are disposed along the pipe 210. A bundling member 380 is wrapped around the wires 100 and the pipe 210. Adhesive tape, a cable tie, or the like is used as the bundling member 380.

Here, components for fixing a wire to the vehicle include a component having an oblong plate-shaped portion molded integrally with its constituent portion as in the case of the vehicle fixing portion 286 described above. The bundling member 380 described above may be wrapped around the wires 100 and the pipe 210 with the plate-shaped portion of this component being bundled together therewith.

According to the present example, by using the bundling member 380, the wires 100 can be easily attached to the pipe 210.

Since the pipe 210 and the wires 100 are supplied in an integrated form, the ease of attachment to the electric automobile 10 is increased. It is also possible that the pipe 210 and the wires 100 are provided in separate forms, and they are integrated with each other when being attached to the electric automobile 10 using the bundling member 380. This allows the attachment operation to be performed in a flexible manner.

Since the wires 100 and the pipe 210 are bundled in a state in which the wires 100 are in contact with the pipe 210, the effect of cooling the wires 100 is increased.

Note that a wire need not necessarily be disposed along the pipe.

The configurations described in the embodiment and the modification may be combined as appropriate as long as there are no mutual inconsistencies. For example, the configurations respectively shown in FIGS. 3, 4, 5, and 6 above may be used in combination as the configuration for disposing the wire along the refrigerant pipe.

### LIST OF REFERENCE NUMERALS

10 Electric automobile

10h Fixing hole

11 Front compartment

12 Passenger compartment

13 Partition wall

20 Temperature management system

30 Air-conditioning refrigerant circuit

31 Degas swirl pot

32 Valve

33 Pump

34 Condenser

35 PTC heater

36 Air-conditioning heat exchanger

37 Pipe

40 High-voltage device refrigerant circuit

40F Front high-voltage device refrigerant circuit

40R Rear high-voltage device refrigerant circuit

41 Pump

42 Valve

43 Cooler

44 Radiator

45 Joint

46 Pipe

48(1), 48(2), 48(3), 48(4) Front high-voltage electric device

48(5), 48(6), 48(7) Rear high-voltage electric device

50 Battery refrigerant circuit

51 Pump

52 Valve

53 Heat exchanger

54 Cooler

56 Pipe

58 Battery

60 Tank

100 Wire

110 Pipe

110B Pipe

112 Pipe body portion

114 Wire holding portion

114B Wire holding portion

115 Slit

210 Pipe

280 Attachment member

282 Pipe attachment portion

283 Opening

284 Wire attachment portion

285 Opening

286 Vehicle fixing portion

286a Base portion

286b Columnar portion

286c Catch portion

380 Member

1. A temperature management system for an electric automobile, comprising:
an air-conditioning refrigerant circuit through which a refrigerant for adjusting a temperature in a passenger compartment of the electric automobile flows;
a high-voltage device refrigerant circuit through which a refrigerant for cooling a high-voltage device flows;
a battery refrigerant circuit through which a refrigerant for cooling a battery flows; and
a tank that stores a refrigerant,
wherein the air-conditioning refrigerant circuit, the high-voltage device refrigerant circuit, and the battery refrigerant circuit are connected to the tank, and a refrigerant is supplied from the tank to the air-conditioning refrigerant circuit, the high-voltage device refrigerant circuit, and the battery refrigerant circuit.

2. The temperature management system according to claim 1,
wherein the battery refrigerant circuit is routed through a lithium ion battery serving as the battery.

3. The temperature management system according to claim 1,
wherein the high-voltage device refrigerant circuit includes a front high-voltage device refrigerant circuit and a rear high-voltage device refrigerant circuit,
the front high-voltage device refrigerant circuit is routed through a front high-voltage device provided on a front side in the electric automobile,
the rear high-voltage device refrigerant circuit is routed through a rear high-voltage device provided on a rear side in the electric automobile, and
the refrigerant from the tank separately flows through the front high-voltage device refrigerant circuit and the rear high-voltage device refrigerant circuit.

4. The temperature management system according to claim 1, further comprising
a radiator that cools a refrigerant,
wherein the high-voltage device refrigerant circuit and the battery refrigerant circuit are routed through the radiator via separate flow paths.

5. The temperature management system according to claim 1, further comprising
a heat exchanger that exchanges heat between the air-conditioning refrigerant circuit and the battery refrigerant circuit.

6. The temperature management system according to claim 1, further comprising
a wire, at least a portion of which is disposed along at least a portion of the air-conditioning refrigerant circuit, the high-voltage device refrigerant circuit, and the battery refrigerant circuit.

7. The temperature management system according to claim 6,
wherein the wire is a wire having a heat-resistant temperature of 175° C. or less in a long-term heat aging test according to ISO 6722, a heat-resistant temperature of 175° C. or less in a short-term heat aging test according to ISO 6722, and a heat-resistant temperature of 175° C. or less in an overload heating test according to ISO 6722.
